(19) United States
(12) Patent Application Publication
(10) Pub. No.: US 2024/0006932 A1
(43) Pub. Date: Jan. 4, 2024

(54) DISTRIBUTED WIRELESS CHARGING NETWORK FOR AUTOMATED GUIDED VEHICLES

(71) Applicant: Yank Technologies, Inc., Brooklyn, NY (US)

(72) Inventor: Joshua Aaron YANKOWITZ, Brooklyn, NY (US)

(73) Assignee: Yank Technologies, Inc., Brooklyn, NY (US)

(21) Appl. No.: 18/252,857

(22) PCT Filed: Nov. 19, 2021
(86) PCT No.: PCT/US2021/072527

§ 371 Date: May 12, 2023

Related U.S. Application Data
(60) Provisional application No. 63/115,982, filed on Nov. 19, 2020.

(51) Int. Cl. H02J 50/90; H02J 50/60; H02J 50/80; H02J 50/40; H02J 7/00; H02J 50/12; B60L 53/39; B60L 53/122; B60L 53/62; B60L 53/66; B60L 53/68

(52) U.S. Cl. CPC H02J 50/90; H02J 50/60; H02J 50/80; H02J 50/40; H02J 7/0048; B60L 53/68; B60L 53/39; B60L 53/122; B60L 53/62; B60L 53/66; H02J 50/12

(57) ABSTRACT

The described technology provides a wireless charging network comprising wireless power transmitters and transmitters nodes distributed along a track or route traversed by automated guided vehicles and other moveable objects. The moveable objects include wireless charging receivers to receive wireless power from the wireless power transmitters and nodes.

### CROSS-REFERENCE TO RELATED APPLICATIONS

This patent document claims priority to and benefit from U.S. Provisional Patent Application No. 63/115,982, entitled “DISTRIBUTED WIRELESS CHARGING NETWORK FOR AUTOMATED GUIDED VEHICLES,” filed on Nov. 19, 2020, which is hereby incorporated by reference in its entirety.

### TECHNICAL FIELD

The present application relates to distributed wireless charging networks.

### BACKGROUND

Automated guided vehicles (AGVs) and similar robotic systems typically require charging for at least one hour for every twenty-three hours of use. This means that the AGVs are idle or are down for maintenance for at least 3% of the time. Conventional AGVs often experience difficulty effectively or efficiently being recharged wirelessly when in use (e.g., when in motion) for several reasons. Conventional charging systems using class D or class E series resonant amplifiers are sensitive to changes in reflected impedance which can occur due to transmitter and receiver coupling. Such wireless charging systems are sensitive to the movement and/or orientation of the AGVs relative to the chargers and the introduction of new devices near the chargers. Trying to charge an AGV using such systems while the AGV is in motion, can often damage the power receiver in the AGV and/or the power transmitter on the charging pad or can be futile as the AGV would not receive enough charging power. This is because the amplifier would be unable to handle the wide range of reflections, the reflections being further exacerbated by the proximity of the power receiver (e.g., underneath the AGV) to the power transmitter (e.g., in the charging pad). There is therefore a need for a wireless charging system that can charge AGVs and other robotic vehicles while the vehicles are in use thereby increasing the uptime and hence productivity of these products.

### BRIEF DESCRIPTION OF THE DRAWINGS

FIG. 1 is a representative block diagram of a wireless power transmitter system.

FIG. 2 is a representative block diagram of a wireless power transmitter node.

FIG. 3 is a representative block diagram of a distributed wireless charging network.

FIG. 4 is a representative illustration of a simplified AGV pathway.

FIG. 5 is a block diagram that illustrates an example of a computer system in which at least some operations described herein can be implemented.

FIG. 6 is a flowchart that illustrates a process for supplying power to a mobile object based on proximity to wireless power transmitters.

### DETAILED DESCRIPTION

A wireless charging network is disclosed which includes one or more wireless power transmitters (i.e., wireless charging transmitters) configured to provide wireless power to one or more wireless power receivers contained in automated guided vehicles (AGVs), other robotic vehicles, industrial equipment, etc. Such vehicles are often used to improve the productivity of factories (e.g., automobile assembly plants) and fulfillment centers. The vehicles include a power source (e.g., a rechargeable battery) that is charged by the transmitters. The wireless power transmitters include one or more transmitter nodes distributed along a path or route traversed by the vehicles (e.g., clustered in certain points along the path or otherwise distributed along the path). In some embodiments, the wireless charging network also include a controller (e.g., software or firmware modules) to control and monitor the transmitter and/or receivers (e.g., to report the charge status of the vehicle batteries) or to selectively activate the transmitters (or transmitter nodes) when the vehicles are physically proximate to the transmitters/nodes (e.g., when the vehicles or moveable/mobile objects are within 1 foot of the transmitters or nodes).

The distributed wireless charging network can charge automated guided vehicles (AGVs) and other robotic vehicles and systems while they are in motion to improve factory productivity (e.g., automobile assembly plant productivity), fulfillment center productivity, etc. In addition to eliminating the need for a human to manually plug in the vehicle to a power source to recharge it, the disclosed technology eliminates the downtime penalty that would be incurred if the AGVs needed to be taken offline (i.e., not available for use) to re-charge. The disclosed technology includes multiple nodes and power transmitters to charge the AGVs or other robotic systems continuously with little to no downtime, e.g., as the AGVs traverse their operation routes or pathways. Several techniques as will be described further below are provided to overcome the challenges of prior-art wireless charging systems. For example, in some embodiments, the wireless power transmitters use a parallel resonant amplifier topology to make the overall system more robust to reflections. Although the disclosed embodiments provide illustrative examples using automated guided vehicles and robotic vehicles, it will be appreciated that the disclosed technology is not limited to such vehicles but encompasses other types of vehicles, including but not limited to, moving electromechanical objects such as surgical arms, kitting carts, mine trams, assembly line robots, etc.

Various embodiments will now be described. The following description provides specific details for a thorough understanding and an enabling description of these embodiments. One skilled in the art will understand, however, that the disclosed techniques can be practiced without many of these details. Additionally, some well-known structures or functions may not be shown or described in detail, to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

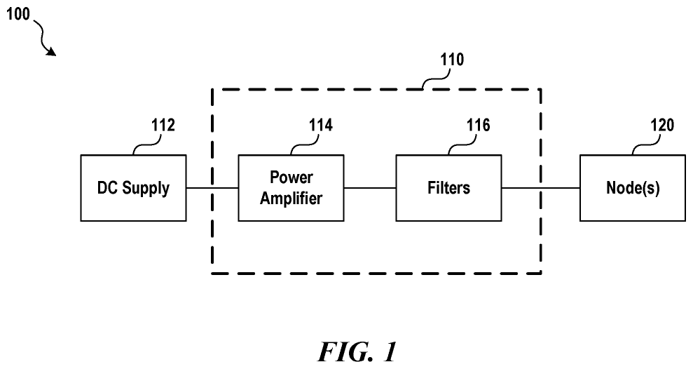

FIG. 1 is a representative block diagram of a wireless power transmitter system 100. In some embodiments, the wireless power transmitter system 100 includes a direct current (DC) supply 112 coupled to one or more wireless power transmitter circuits 110. The wireless power transmitter circuit 110 is coupled to one or more wireless power transmitter nodes 120. One or more wireless power transmitter systems 100 are arranged along the expected path of the AGVs, robotic, or other moveable objects allowing the wireless power transmitters to charge the vehicles or moveable objects dynamically while they are in motion (i.e., the vehicles, moveable or mobile objects need not be taken offline to be wirelessly charged).

The DC supply 112 powers a power amplifier 114 (e.g., parallel resonant amplifiers), and filters 116 to reduce harmonics and electromagnetic interference (EMI) (i.e., for electromagnetic compatibility (EMC)).

The output of the wireless power transmitter circuit 110 is coupled to one or more wireless power transmitter nodes 120. Depending on the circuit components and amplifier topology of the wireless power transmitter circuit 110, there may be multiple nodes 120 for a single wireless power transmitter system 100.

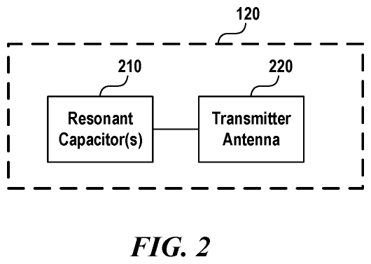

FIG. 2 is a representative block diagram of a wireless power transmitter node 120. In some embodiments, the wireless power transmitter node 120 is an inductor-capacitor circuit (e.g., an LC tank circuit) including resonant capacitors 210 and a transmitter antenna 220 tuned to the operating frequency of the wireless power transmitter. A system can include multiple wireless power transmitter circuits (e.g., multiple transmitter circuit 110 in FIG. 1) with each wireless power transmitter circuit having multiple wireless power transmitter nodes 120. Each one of the wireless power transmitter nodes includes one or more resonant capacitors tuned to substantially excite each the transmitter antennas at an operating frequency of the wireless power transmitters.

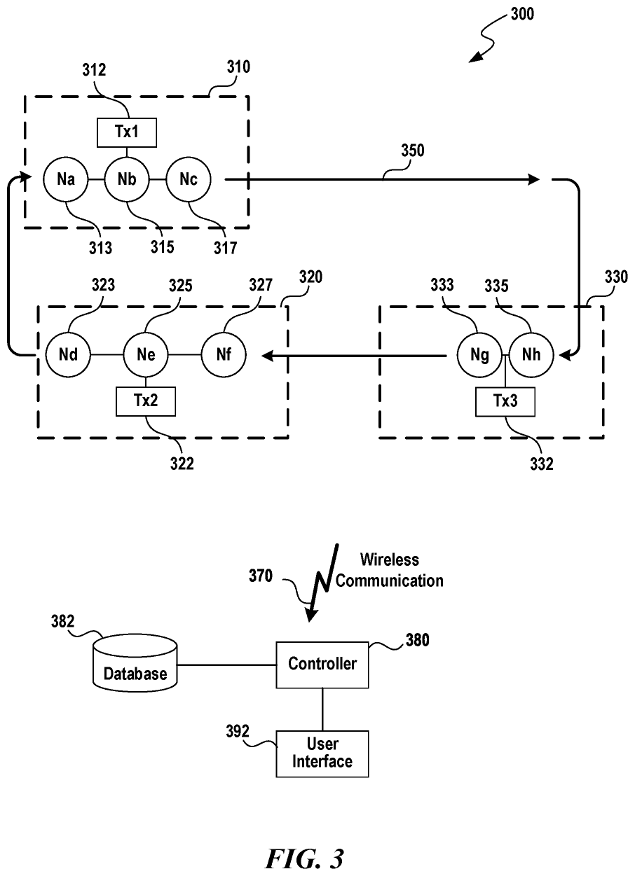

FIG. 3 is a representative block diagram of a distributed wireless charging network 300. The example distributed wireless charging network 300 includes three wireless power transmitter systems 310, 320, and 330. Wireless power transmitter system 310 includes three wireless power transmitter nodes (nodes 313, 315, and 317); wireless power transmitter system 320 also includes three wireless power transmitter nodes (nodes 323, 325, and 327); and, wireless power transmitter system 330 includes two wireless power transmitter nodes (nodes 333 and 335).

The eight wireless power transmitter nodes are arranged along a path or track 350, e.g., an elliptical path that the AGV or robotic vehicle follows while operating. The wireless power transmitter systems are arranged such that the vehicles maintain roughly the same charge capacity after they complete each lap or task thereby eliminating the need to take the vehicles offline to recharge. This improves productivity and reduces the cost of the vehicles because a plant would require less vehicles for the same workload.

The distribution and placement of the transmitter systems and nodes is customized based on the specific application and plant or work site, number of transmitters/nodes available, power load requirements, output power capacity of the transmitters, number of vehicles to be charged, etc. For example, although both wireless power transmitter systems 310 and 320 have the same number of nodes (three nodes each), the nodes 313, 315, and 317 of wireless power transmitter system 310 are spaced closer together than the nodes 323, 325, and 327 of wireless power transmitter system 320 are. The number of nodes as well as the distance between each of the nodes for each transmitter in the network may be different depending on the requirements of the devices in the network. This also includes the shape of the pathway. Although FIG. 3 shows an elliptical pathway, it will be appreciated that the pathway can take on different shapes depending, for example, on the layout of the specific factory or fulfillment center in which the wireless charging system is implemented.

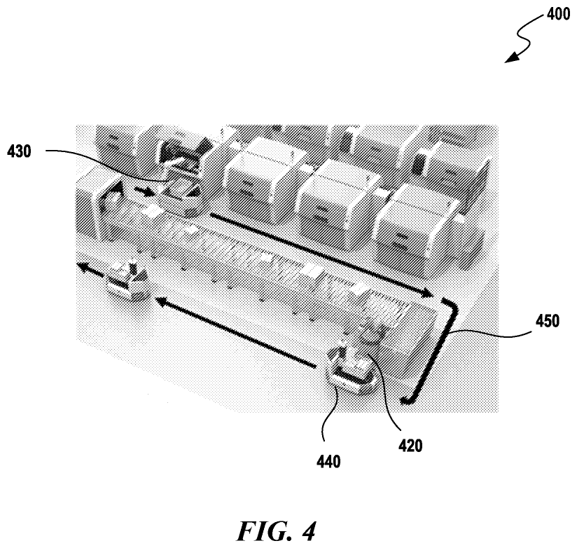

In some embodiments, the wireless power transmitter systems are arranged in clusters (as shown in FIG. 3) instead of linearly along the track 350 based on the activity of the vehicles along the track 350. For example, wireless power transmitter system 330 can be placed at a package pickup point of the vehicles (e.g., pickup point 420 in FIG. 4) and wireless power transmitter system 310 can be placed at a package drop-off point (e.g., drop-off point 430 in FIG. 4). Wireless power transmitter system 320 can be placed at the approximate mid-point of the path between the package pickup and drop-off points. The charging transmitters and its nodes are clustered around package pickup and drop-off points because the vehicles linger longest at these locations (e.g., the vehicles stop to load and unload packages thereby spending more time at these locations and allowing more time for stationary recharging). Adding more charging transmitters and nodes at these locations allow the vehicles to charge faster (i.e., to charge to a higher capacity) when at these locations thereby reducing the number of transmitters and nodes that need to be placed elsewhere along the track 350.

In some embodiments, the wireless power transmitter systems are distributed along the track 350. Although this may require more transmitters and nodes than the clustered placement described above, this may result in other benefits, for example, by allowing a more uniform charging profile as the vehicle moves along the track 350. This uniform charging profiles contrasts the more rapid charging obtained in the clustered placement where the vehicles are charged more rapidly while stationary at pickup and drop-off locations. It therefore may have additional benefits, such as the reduction of the rechargeable battery capacity or the elimination of the battery since power is received at each access point along the path of the device.

In some embodiments, the distributed wireless charging network 300 includes software and firmware in addition to the hardware described above. The software/firmware monitors the entire system (e.g., wireless power transmitter systems and wireless power receivers that power the vehicles) in real-time or periodically to improve the efficiency of the system (e.g., improve overall productivity of the assembly/manufacturing plant or fulfillment center). The software does this in various ways.

For example, on the receiver side (e.g., on the wireless charging receivers coupled to the AGVs or robotic vehicle power sources), the software can monitor the battery capacity of the vehicles in the distributed wireless charging network 300 to ensure that the system is working properly. This can be achieved by measuring the battery capacity of the vehicles and sending a communication signal (e.g., via a wired connection or a wireless communication link 370) to a controller 380 and/or a database 382. The controller 382 or user (e.g., via a user interface 392) monitors the signal in the database 382 to determine the status of the vehicle.

In some implementations, if the wireless charging receiver is integrated in the AGV or robotic vehicle, the vehicle can transmit positioning information (e.g., GPS coordinates or other positioning data) to the database 382, which can indicate the position of the wireless receiver and vehicle along the track 350. Additionally, the wireless power receiver can communicate its battery status to the controller 380 and/or database 382. This is true for both automated vehicles as well as other types of manual vehicles and factory equipment, such as kitting carts. Kitting carts are push carts with factory parts, such as doors and bumpers, that are placed and labelled by workers. Kitting carts often have embedded electronics for indicating the location and part type and can be manually pushed to various locations across the factory floor.

Additionally, on the transmitter side, firmware in a microcontroller (MCU) of the wireless power transmitter system can detect the presence of a wireless charging receiver by measuring the reflected impedance. Additionally or alternatively, a vehicle can trigger a sensor along track 350 when the vehicle is proximate to a wireless power transmitter node (e.g., when in close physical or spatial proximity). The software or firmware can enable or activate one or more nodes or all nodes, e.g., by enabling a power amplifier in a wireless power transmitter circuit (e.g., wireless power transmitter circuit 110 in FIG. 1). For example, detecting the presence of a wireless charging receiver (hence presence of a vehicle) can cause the software/firmware to trigger a power switch to enable the wireless power transmitter system or individual node(s). This ensures that the wireless power transmitters are only emitting power when the vehicle is physically proximate to the wireless power transmitters and associated nodes which leads to power savings for the entire system. In some embodiments, the software/firmware enables/disable the wireless power transmitters or the wireless power transmitter nodes based on the spatial location of the vehicle or moveable object through software/firmware instructions in a non-transitory memory (e.g., RAM) of a processor coupled to the wireless charging network 300. The software/firmware can also send a communication signal to the database 382 and/or controller 380 when a wireless power transmitter system or its associated node(s) are activated to power a wireless charging receiver.

FIG. 4 is a representative illustration of a simplified AGV pathway 400. In this example pathway of FIG. 4, the AGVs (e.g., AGV 440) move in a continuous elliptical loop around a track 450 in a fulfillment center or other plant (e.g., assembly plant). As described above in relation to FIG. 3, wireless power transmitter systems can be placed at various points along the track 450. For example, a wireless charging system can be placed at a package pickup point 420 (e.g., wireless power transmitter system 330 in FIG. 3), and a separate wireless charging system can be placed at a package drop-off point 430 (e.g., wireless power transmitter system 310 in FIG. 3). Although FIG. 4 is depicted using AGVs in a package processing plant, it will be appreciated that the disclosed technology applies generally to a system comprising a moveable track on which a moveable object is located (i.e., a moveable vehicle). The system includes a bank of wireless transmitters configured to provide wireless power to the moveable object while the moveable object is in motion or when the moveable object is stationary such as at pickup point 420 and drop-off point 430.

In some embodiments, the transmitters in the bank of wireless transmitters operate collaboratively or jointly to provide wireless power to the moveable object using the nearest node(s) of the wireless transmitters. For example, if there is only one transmitter in the bank, it would be solely responsible to charging the moveable object. However, there may still be multiple nodes controlled by this single transmitter. If there are two transmitters, then one or both would power the moveable object depending on where the moveable object is positioned relative to each transmitter. Furthermore, all or some of the nodes of that transmitter may be enabled depending on the moveable object's positioning along the pathway. For example, the transmitter node closest to the moveable object or the transmitter node to which the moveable object is moving towards could charge the moveable object when the moveable object is closer to that transmitter rather than to the nodes of the transmitter it is moving away from. In some embodiments, the moveable object can be configured to receive power from multiple transmitters simultaneously where the one or more transmitters closest to the moveable object would provide a constant or variable amount of power to the moveable object. That is, each power transmitter could transmit a different amount of power based on how far the moveable object was to it or could transmit a constant amount of power regardless of the position of the moveable object provide the moveable object is within a certain distance.

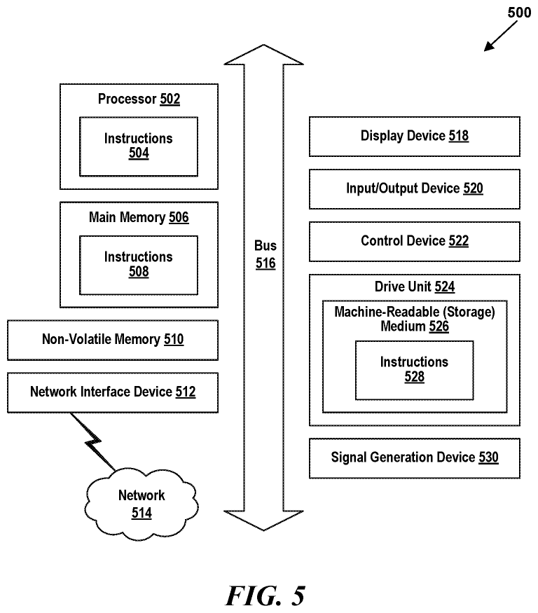

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure. It is noted that certain embodiments may include only a portion of the above-described components of the computer system 500. For example, some embodiments may simply use a processor and a memory, while some embodiments may include a communication interface.

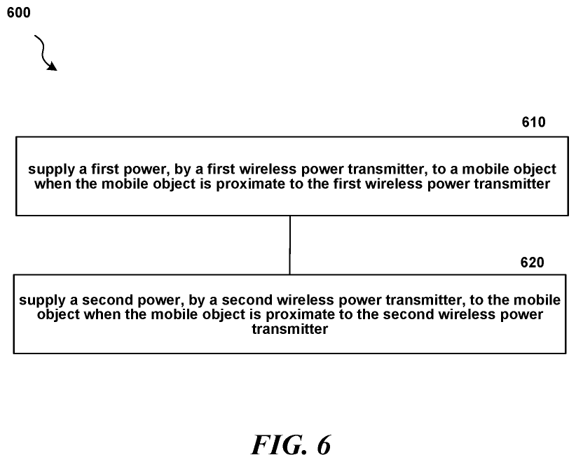

FIG. 6 is a flowchart that illustrates a process for supplying power to a mobile object based on proximity to wireless power transmitters. At block 610, a first wireless power transmitter supplies power to the mobile object when the mobile object is physically proximate to the first wireless power transmitter (i.e., when the mobile object is near the first power transmitter, e.g., less than a few feet from the first power transmitter).

At block 620, a second wireless power transmitter supplies power to the mobile object when the mobile object is physically proximate to the second wireless power transmitter (i.e., when the mobile object is near the second power transmitter, e.g., less than a few feet from the second power transmitter).

U.S. Patent Application No. 62/736,843, and PCT Application No. PCT/US2019/053266, which published as WO 2020/069198 on Apr. 2, 2020, incorporated by reference in entirety herein, describes some example parallel resonant amplifier topologies for wireless power transmitters that can be used with the technology described herein.

A listing of solutions that is preferably implemented by some embodiments can be described using the following clauses.

Clause 1. A wireless charging network comprising: a first wireless power transmitter and a second wireless power transmitter, wherein the first and second wireless power transmitters are configured to provide power to a moveable object; at least one processor coupled to the wireless charging network; and at least one memory, coupled to the at least one processor, and storing instructions for enabling and disabling the first and second wireless power transmitters based on a spatial location of the moveable object. In some implementations, the type of moveable object determines how much power is output from the power transmitter (e.g., output more power to an ultrasound machine vs a portable pulse oximeter). The type of device can be determined from direct communication between the device and power transmitter (e.g., backscatter modulation transmission) or could be based on properties of the power coupled to the device (e.g., current drawn, reflections, etc.).

Clause 2. The wireless charging network of clause 1, wherein the first wireless power transmitter comprises a first set of wireless charging nodes and the second wireless power transmitter comprises a second set of wireless charging nodes, wherein each node of the first set and the second set of wireless charging nodes comprises one or more capacitors and an antenna, wherein the one or more capacitors are tuned to substantially excite the antenna at an operating frequency of the first or the second wireless power transmitter.

Clause 3. The wireless charging network of clause 2, wherein the first set of wireless charging nodes comprises a different number of wireless charging nodes than the second set of wireless charging nodes.

Clause 4. The wireless charging network of clause 2, wherein the first set of wireless charging nodes comprises wireless charging nodes spaced at a first distance from each other and the second set of wireless charging nodes comprises wireless charging nodes spaced at a second distance from each other, wherein the first distance and the second distance are different.

Clause 5. The wireless charging network of clause 1, wherein the first wireless power transmitter is further configured to detect a physical proximity of the moveable object to the first wireless power transmitter and enable a power transmission from the first wireless power transmitter when the moveable object is detected to be physically proximate to the first wireless power transmitter. In some embodiments, the detection of physical proximity may be implemented as a binary logic—e.g., a threshold comparison resulting in one of two decision—either the moveable object is close by, or not. In some embodiments, a multi-level approach may be used where the physical proximity may be expressed in multiple proximity levels for the operation.

Clause 6. The wireless charging network of clause 1, further comprising a database configured to receive a communication signal indicating a charge remaining in a power source of the moveable object. The communication signal may use an industry standard protocol such as WI-FI or BLUETOOTH or using modulation of the power signal itself.

Clause 7. The wireless charging network of clause 5, wherein detecting the physical proximity of the moveable object to the first wireless power transmitter comprises detecting a wireless charging receiver by measuring a reflected impedance or a change in current draw in the first wireless power transmitter. For example, the presence of the moveable/mobile object could be binary in nature (e.g., object is present or not present in charging zone around power transmitter) or the presence could be analog (e.g., based on current draw or reflected impedance, the object can be detected to be within a certain distance from the power transmitter). Proximity of the object can also be determined in other ways such as indoor positioning (e.g., Wi-Fi, Bluetooth, NFC, or other sensor-based positioning) or GPS/GNSS positioning within the building or warehouse/factory floor. In some implementations, the amount of power output from the power transmitter is based on how far the device is to the power transmitter.

Clause 8. The wireless charging network of clause 2, wherein a number of wireless charging nodes in the first set and the second set of wireless charging nodes is based on a number of moveable objects adapted to receive power from the wireless charging network.

Clause 9. The wireless charging network of clause 2, wherein the first set of wireless charging nodes are arranged around a first point in a track traversed by the moveable object, and the second set of wireless charging nodes are arranged around a second point in the track, wherein the first set of wireless charging nodes comprises a larger number of wireless charging nodes than the second set of wireless charging nodes when the moveable object spends more time around the first point than around the second point.

Clause 10. A method implemented on a wireless charging network for supplying power to mobile objects, the method comprising: supplying a first power, by a first wireless power transmitter, to a mobile object when the mobile object is proximate to the first wireless power transmitter; and, supplying a second power, by a second wireless power transmitter, to the mobile object when the mobile object is proximate to the second wireless power transmitter.

Clause 11. The method of clause 10, wherein supplying the first power to the mobile object comprises: detecting that the mobile object is proximate to the first wireless power transmitter; and, enabling the first wireless power transmitter in response to detecting that the mobile object is proximate to the first wireless power transmitter.

Clause 12. The method of clause 10, further comprising monitoring, by a controller, the power charge status of the mobile object.

Clause 13. The method of clause 10, further comprising transmitting, by the mobile object, a communication signal to a database in the wireless charging network, wherein the communication signal indicates a charge remaining in the mobile object.

Clause 14. The method of clause 11, wherein detecting that the mobile object is proximate to the first wireless power transmitter comprises measuring a reflected impedance in the first wireless power transmitter.

Clause 15. The method of clause 11, further comprising transmitting, by the first wireless power transmitter, a communication signal to a database in the wireless charging network in response to enabling the first wireless power transmitter, wherein the communication signal indicates that the first wireless power transmitter has been enabled.

Clause 16. A system comprising: a moveable track on which a moveable object is located; and, a bank of wireless transmitters configured to provide wireless power to the moveable object.

Clause 17. The system of clause 16, wherein the bank of wireless transmitters operates to control the providing the wireless power to the moveable object using a nearest N number of wireless transmitters.

Clause 18. The system of clause 17, wherein N=1.

Clause 19. The system of clause 17, wherein N=2, and the nearest N wireless transmitters includes a first wireless transmitter from which the moveable object is moving away and a second wireless transmitter towards which the moveable object is moving.

### REMARKS

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention considering the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A wireless charging network comprising:
a first wireless power transmitter and a second wireless power transmitter,
wherein the first and second wireless power transmitters are configured to provide power to a moveable object;
at least one processor coupled to the wireless charging network; and
at least one memory, coupled to the at least one processor, and storing instructions for enabling and disabling the first and second wireless power transmitters based on a spatial location of the moveable object.

2. The wireless charging network of claim 1, wherein the first wireless power transmitter comprises a first set of wireless charging nodes and the second wireless power transmitter comprises a second set of wireless charging nodes, wherein each node of the first set and the second set of wireless charging nodes comprises one or more capacitors and an antenna, wherein the one or more capacitors are tuned to substantially excite the antenna at an operating frequency of the first or the second wireless power transmitter.

3. The wireless charging network of claim 2, wherein the first set of wireless charging nodes comprises a different number of wireless charging nodes than the second set of wireless charging nodes.

4. The wireless charging network of claim 2, wherein the first set of wireless charging nodes comprises wireless charging nodes spaced at a first distance from each other and the second set of wireless charging nodes comprises wireless charging nodes spaced at a second distance from each other, wherein the first distance and the second distance are different.

5. The wireless charging network of claim 1, wherein the first wireless power transmitter is further configured to detect a physical proximity of the moveable object to the first wireless power transmitter and enable a power transmission from the first wireless power transmitter when the moveable object is detected to be physically proximate to the first wireless power transmitter.

6. The wireless charging network of claim 1, further comprising a database configured to receive a communication signal indicating a charge remaining in a power source of the moveable object.

7. The wireless charging network of claim 5, wherein detecting the physical proximity of the moveable object to the first wireless power transmitter comprises detecting a wireless charging receiver by measuring a reflected impedance or a change in current draw in the first wireless power transmitter.

8. The wireless charging network of claim 2, wherein a number of wireless charging nodes in the first set and the second set of wireless charging nodes is based on a number of moveable objects adapted to receive power from the wireless charging network.

9. The wireless charging network of claim 2, wherein the first set of wireless charging nodes are arranged around a first point in a track traversed by the moveable object, and the second set of wireless charging nodes are arranged around a second point in the track, wherein the first set of wireless charging nodes comprises a larger number of wireless charging nodes than the second set of wireless charging nodes when the moveable object spends more time around the first point than around the second point.

10. A method implemented on a wireless charging network for supplying power to mobile objects, the method comprising:
supplying a first power, by a first wireless power transmitter, to a mobile object when the mobile object is proximate to the first wireless power transmitter; and,
supplying a second power, by a second wireless power transmitter, to the mobile object when the mobile object is proximate to the second wireless power transmitter.

11. The method of claim 10, wherein supplying the first power to the mobile object comprises:
detecting that the mobile object is proximate to the first wireless power transmitter; and,
enabling the first wireless power transmitter in response to detecting that the mobile object is proximate to the first wireless power transmitter.

12. The method of claim 10, further comprising monitoring, by a controller, a power charge status of the mobile object.

13. The method of claim 10, further comprising transmitting, by the mobile object, a communication signal to a database in the wireless charging network, wherein the communication signal indicates a charge remaining in the mobile object.

14. The method of claim 11, wherein detecting that the mobile object is proximate to the first wireless power transmitter comprises measuring a reflected impedance in the first wireless power transmitter.

15. The method of claim 11, further comprising transmitting, by the first wireless power transmitter, a communication signal to a database in the wireless charging network in response to enabling the first wireless power transmitter, wherein the communication signal indicates that the first wireless power transmitter has been enabled.

16. A system comprising:
a moveable track on which a moveable object is located; and
a bank of wireless transmitters configured to provide wireless power to the moveable object.

17. The system of claim 16, wherein the bank of wireless transmitters operates to control the providing the wireless power to the moveable object using a nearest N number of wireless transmitters.

18. The system of claim 17, wherein N=1.

19. The system of claim 17, wherein N=2, and the nearest N wireless transmitters includes a first wireless transmitter from which the moveable object is moving away and a second wireless transmitter towards which the moveable object is moving.

20. (canceled)
